(19) United States
(12) Patent Application Publication
(10) Pub. No.: US 2003/0088640 A1
(43) Pub. Date: May 8, 2003

(54) Web user interface for simplifying use and administration of a computer network through a single portal

(76) Inventors: Abizer T. Rasheed, West Bloomfield, MI (US); Jeremy W. Goerlich, Port Huron, MI (US)

Correspondence Address: ARNOLD S. WEINTRAUB, PLUNKETT & COONEY, P.C., 38505 WOODWARD AVENUE, SUITE 2000, BLOOMFIELD HILLS, MI, 48304, US

(21) Appl. No.: 10/233,904

(22) Filed: Sep. 3, 2002

Related U.S. Application Data
(60) Provisional application No. 60/316,786, filed on Aug. 31, 2001.

(51) Int. Cl. G06F 15/16

(52) U.S. Cl. 709/217

(57) ABSTRACT

A preferred embodiment of a computer network includes at least one client device, a server network, and a web user interface having a single portal operably connecting the client device to the server network. In another aspect of the present invention, a method for using the computer network having a single portal web user interface includes the steps of accessing an application object builder through the portal to be displayed on a client device, and using the application builder to create a customized application object that is stored within a memory location of a memory device.

### CROSS-REFERENCE TO RELATED APPLICATIONS

This is a completion Patent Application and under 35 USC Section 119 (e) claims a priority date of Aug. 31, 2001 from co-pending U.S. Provisional Patent Application Serial No. 60/316,786, the disclosure of which is hereby incorporated by reference.

### COPYRIGHT NOTICE

A portion of the disclosure of their patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

This patent document has an appendix containing one hundred sixty six (166) sheets of computer printouts. The appendix is a list of computer programs and related data for one embodiment of the invention that is described below.

### BACKGROUND OF THE INVENTION

1. Field of the Invention

The present invention relates to an improved computer network having a web-based computer interface and a method of using, and more particularly to a client device having an interactive web-access browser, the client device employing a web user interface (“WUI”) to gain access to web-enabled applications through a single portal in communication with a scalable server network.

2. Description of the Prior Art

Prior art networks have a complicated application and services deployment that use a granular architecture. Many of the existing deployment methods used in the prior art strain time, money and human resources. It is desirable to improve communications between network servers to evenly distribute the network load and provide better performance, more concurrent users, and to increase scalability.

An improved computer network having a WUI makes accessing webbased computer programs easier. For example, a single portal WUI can provide easy access to a client for retrieval of web-based application programs stored on a server network accessible through either wired or wireless connections. Application programs may be retrieved from an Internet web server directly connected to the Internet or from a central server network such as a Local Area Network, Wide Area Network, or Virtual Private Network capable of communicating with the Internet. Retrieving information and customizing the retrieved application programs for a specific client device can be easily accomplished.

To increase information retrieval and the customization of retrieved application programs, it is desirable to modularize the application programs used on the network so that different modules can be developed and maintained separately. To this end, a database portion of an application is taken out and developed as a separate module and accessed via a database interface stored in a central memory location. This application database can then be accessed by a WUI.

Computer networks employing WUI's for accessing and retrieving webbased information exist in the prior art; however, these prior art WUl's do not include the capability to have a single authentication process to access a single portal in communication with a network of servers, the servers capable of communicating with a plurality of platforms, and retrieving web-based information including web conferencing and E-mail and application programs according to user defined preferences.

Existing WUI's for accessing and retrieving web-based information and application programs are not designed specifically to transfer information to a client device with minimal user effort. Some WUI's for accessing and retrieving web-based information and application programs provide no means to have a single authentication process to directly transfer the programs or information to a client. The authorization and preferences to the applications programs of the prior art is stored on the client device requiring a separate authorization to access each application program. Programs like Citrix Metaframe expands this authorization process by allowing the authorization process to reside on a server in communication with the client device. However, the Citrix program does not provide a single portal for web and network access.

Instead, the prior art WUI requires the client to access information through the Internet by entering in a different Universal Resource Locator (“URL”) and password for each Internet portal entered to access an Internet web server. A different portal is opened for each type of application accessed by typing in a particular Internet URL. If one of these portals were to crash, the entire connection and access to the network servers would be lost.

Using prior art WUI's to access isolated web sites and application programs does not allow for cross-communication between the websites and the application programs. Current access to the web allows for individual web pages to individual users. These pages are mainly static HTML pages that allow for limited browser collaboration that the end user can manipulate or analyze.

The improved computer network having a WUI of the present invention provides access to an improved server network through a single portal using a single authentication process. Additionally, the improved computer network having a WUI excels the use of a portal by making the use interactive and dynamic instead of static, thus customizing the information and applications accessed and retrieved through the portal.

### SUMMARY OF THE INVENTION

This invention provides solutions to the problems found in the prior art by making use of modern web technologies to improve delivery of network services.

An object of this invention is to simplify use and administration of an integrated computer network by providing a service-based model for designing and implementing a distributed network having five broad categories comprising: Client, Interface, Application, Transaction, and Storage.

A further object of this invention is to use portal technology via a modular WUI to deliver network services regardless of client platform to a client device in one unified interface thus increasing a user's productivity by providing instant access to tools and relevant information.

A further object of this invention is to easily customize application objects, application programs, and web-based tools.

A further object of this invention is to provide a client device continuous access to a network of servers through a single portal connection.

A further object of this invention is to enable users to securely access computer applications via a secure authentication process around the world via the public Internet.

A further object of this invention is to enable users to securely access via a secure wired or wireless authentication process computer applications around the world via the public Internet.

A further object of this invention is to improve communications between network servers and evenly distribute network load thus providing better performance, more concurrent users, and increased scalability.

A further object of this invention is to provide expandable storage and a means to access the expandable storage to logically move large volumes of data quickly without crashing the network.

In accordance therewith, the invention herein is directed to an improved computer network having a WUI and method of use. In particular, in a first preferred embodiment according to this invention, there is provided an improved computer network comprising:

A. a client device having a configurable display capable of interfacing with an application object builder and means for displaying the application through the client device;

B. a server network, the server network comprising:

a. a web user interface having a single portal for interfacing between the client device and the server network;

b. a plurality of servers, the plurality of servers being in communication with the portal comprising

i. at least one terminal service, wherein the terminal service being in communication with application programs and files, and an application object builder,

ii. at least one Internet web server, the at least one terminal service and the at least one Internet web server are in communication with one another and are each in further communication with the WUI,

C. means for storing memory, and

D. means for communicating between the server network and the client device.

Further, and according to this invention, a method of using the improved computer network having a WUI to modify a customized application object comprises the step of:

a. using the WUI to access the application object builder through the portal;

b. displaying an application object and an application program retrieved from the terminal service on the client device;

c. using the application object builder to modify the application program retrieved from the terminal service on the client device according to an end-user's preference; and

d. storing the modified application program in an application object database in communication with the terminal service.

### BRIEF DESCRIPTION OF THE DRAWINGS

The various features, advantages, and other uses of the present invention will become more apparent by referring to the following detailed description and drawings in which:

FIG. 1 is a block diagram of an improved computer network of the present invention;

FIG. 2 is a view of the network architecture of the improved computer network according to the present invention;

FIG. 3 is an illustration of a log-on pop-up screen for obtaining access from a client device to a server network having a WUI in accordance with the present invention;

FIG. 4 is an illustration of an initialization screen for accessing a WUI session;

FIG. 5 is an illustration of a display screen of an application object builder wizard displayed on a WUI desktop in accordance with the present invention;

FIG. 6 is an illustration of another display screen of the application object builder wizard displayed on the WUI desktop in accordance with the present invention;

FIG. 7 is an illustration of another display screen of the application object builder wizard displayed on the WUI desktop in accordance with the present invention;

FIG. 8 is an illustration of another display screen of the application object builder wizard displayed on the WUI desktop in accordance with the present invention;

FIG. 9 is an illustration of another display screen of the application object builder wizard displayed on the WUI desktop in accordance with the present invention;

FIG. 10 is an illustration of another display screen of the application object builder wizard displayed on the WUI desktop in accordance with the present invention;

FIG. 11 is an illustration of another display screen of the application object builder wizard displayed on the WUI desktop in accordance with the present invention;

FIG. 12 is an illustration of another display screen of the application object builder wizard displayed on the WUI desktop in accordance with the present invention;

FIG. 13 is an illustration of another display screen of the application object builder wizard displayed on the WUI desktop in accordance with the present invention;

FIG. 14 is illustration of a display screen of an application object eraser wizard displayed on a WUI desktop in accordance with the present invention;

FIG. 15 is illustration of another display screen of the application object eraser wizard displayed on a WUI desktop in accordance with the present invention;

FIG. 16 is illustration of another display screen of the application object eraser wizard displayed on a WUI desktop in accordance with the present invention;

FIG. 17 is an illustration of a log-off pop-up menu for exiting a WUI session according to the present invention;

FIG. 18 is an illustration of an existing application object viewed on a WUI desktop according to the present invention;

FIG. 19 is an illustration of an existing application object viewed on a WUI desktop according to the present invention;

FIG. 20 is an illustration of an existing text application object viewed on a WUI desktop according to the present invention; and

FIG. 21 is an illustration of a preferences menu according to the present invention.

### DESCRIPTION OF THE PREFERRED EMBODIMENT

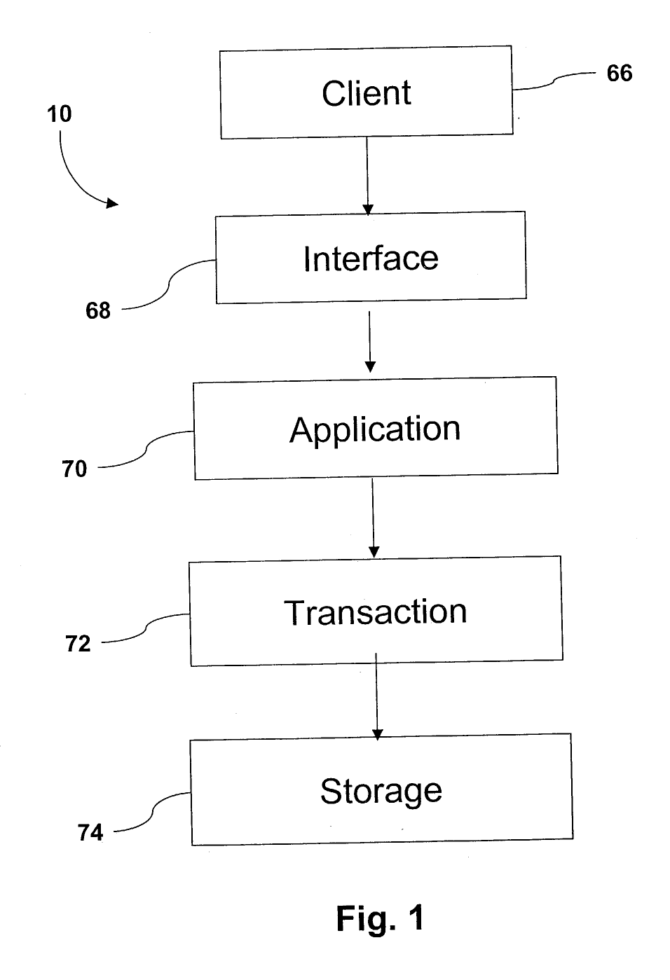

Referring now to the drawings, FIG. 1 shows an improved computer network 10 that uses a WUI to access a network of servers through a single portal. Computer network 10 generally comprises a client layer 66, a user interface layer 68, an applications layer 70, a transactions layer 72, and a storage layer 74.

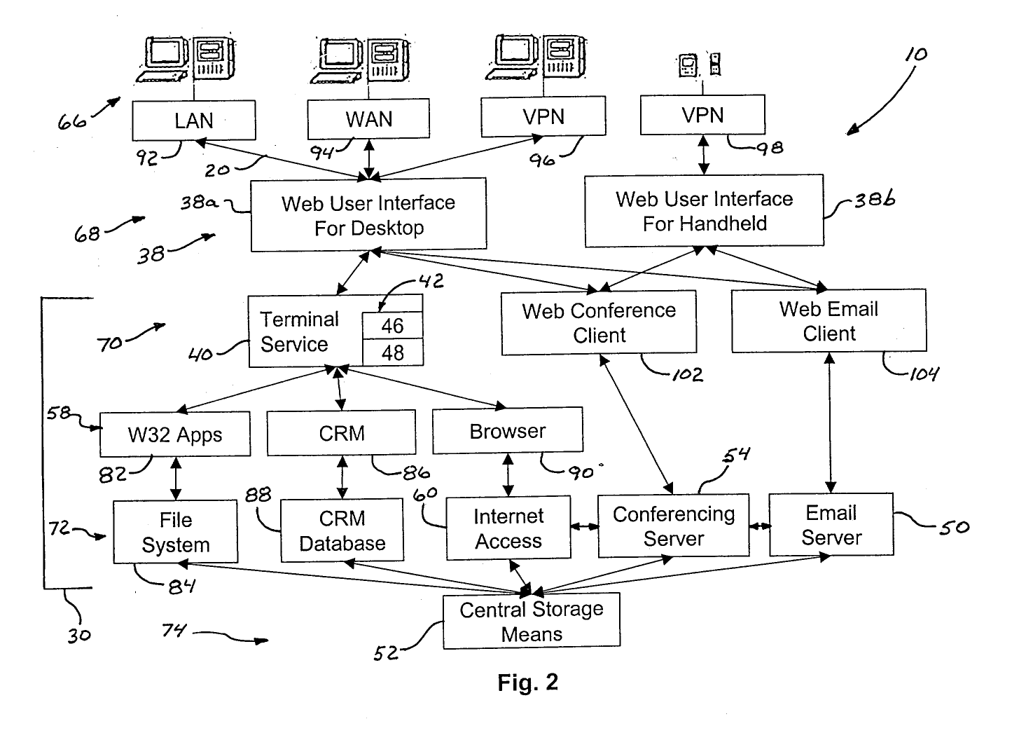

Referring to FIG. 2, computer network 10 is further comprised of at least one client device 12, a server network 30, a WUI 38 having a single portal (not shown) in communication with both the server network 30 and the client device 12, means for storing memory 52, and means for communicating between the client device 12 and the server network 30. The improved computer network is designed to support cross-platforms including but not limited to Windows PCs, Apple Macintosh, UNIX/Linux systems, PDA's and web-enabled cell-phones.

Client device 12 is preferably comprised of at least one computer 24. A plurality of computers 24 may be networked together through a LAN 92, a WAN 94, a VPN 96 wired network, a wireless VPN 98 network, or any combination thereof, to form the client layer 66 of the improved computer network 10. Client device 12 includes a configurable display device 28 for displaying information communicated via the WUI portal 38 to client device 12. Configurable display 28 is preferably a monitor having a configurable browser 14. Browser 14 is capable of displaying text and graphic images communicated to the configurable display via the WUI portal 38.

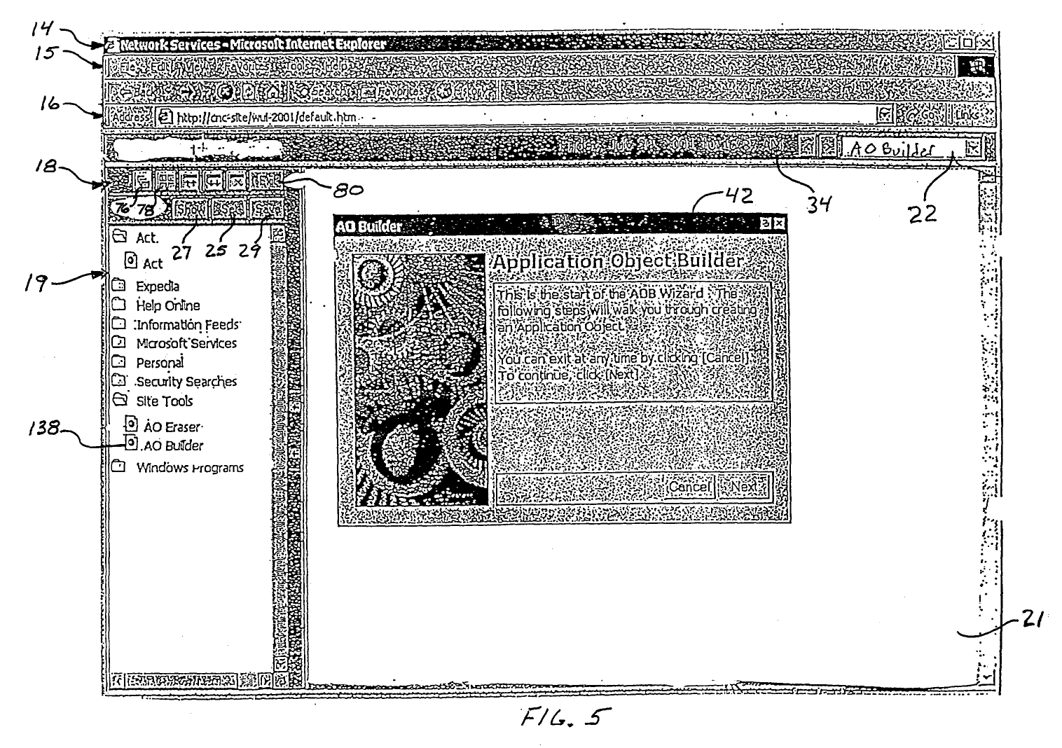

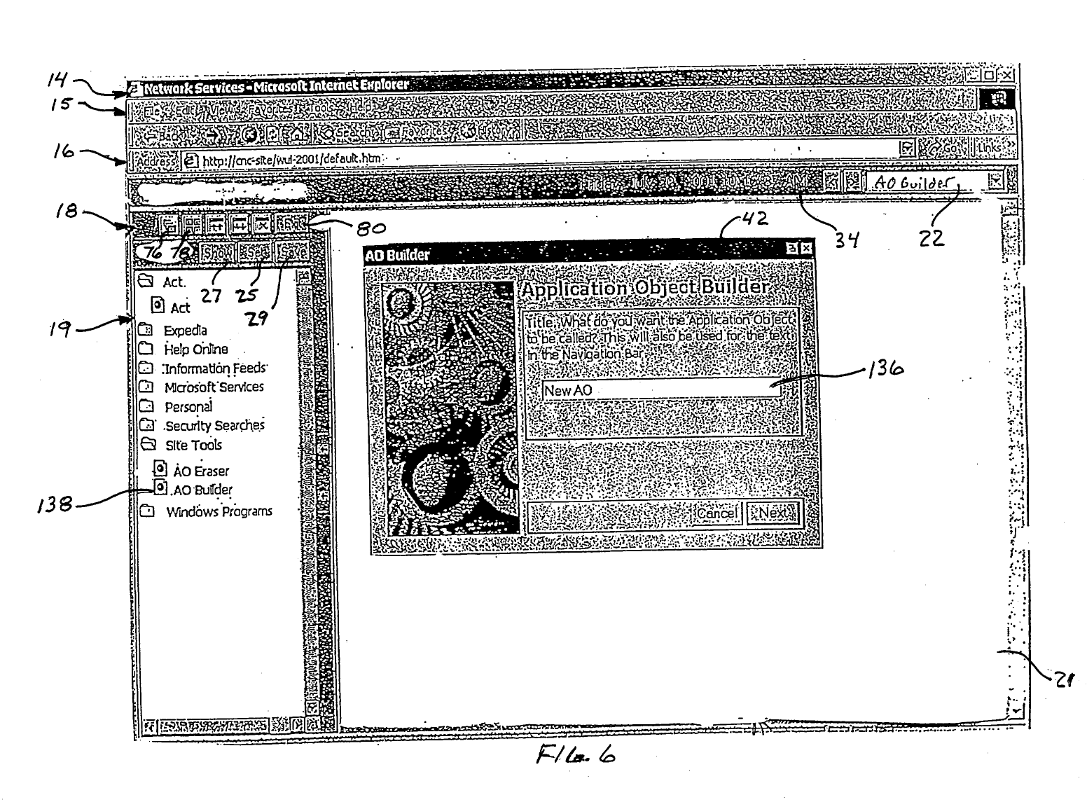

The configurable browser 14, as shown in FIGS. 5-18, has a menu bar 15 providing access to display menu options well known in the software application arts including but not limited to File, Edit, View, Favorites, Tools, and Help. In addition, the configurable browser 14 has an address bar 16 having a URL address entering portion for entering in a desired URL. The URL address links the client device 12 to the WUI portal 38.

Configurable browser 14 further comprises a command bar 18 having a plurality of display preference buttons, including but not limited to, a button for displaying applications in a tiled format 76, a button for displaying applications in a checkerboard format 78, and an EXIT button 80 for exiting a WUI session; a jump bar for selecting and viewing the computer files and programs; and a menu catalog of web user interface files 19 showing the folders and files available on a server network, which is further described below. The menu catalogs 19 may be maximized or minimized according to a user's preference. Also, the configurable display screen 14 has a WUI desktop 21 for displaying information retrieved via the WUI portal 38.

As shown in FIG. 2, the user interface layer 68 includes a WUI for interfacing between the client device 12 and the server network 30. The WUI may be in the form of a WUI 38a for use with wired networks 92, 94 and 96, or a WUI 38b used with wireless network 98. The WUI preferably has means for authenticating a user and means for securing access to the server network 30.

The application layer 70 and the transaction layer 72 cooperate to form the server network 30. The server network 30 comprises a plurality of servers that are in communication with the WUI. Preferably, the plurality of servers comprise at least one terminal service 40, at least one web conferencing server 54, and at least one E-mail server 50. Terminal service 40 and servers 50 and 54 are each in communication with each other and with the WUI 38. Additionally, terminal service 40 and servers 50 and 54 are in communication with a central storage means 52. It should be noted that, depending on the specific needs of a user, either terminal service 40, server 50, or server 54 may be eliminated.

Terminal service 40 provides windows terminal services. At least one of the terminal service 40 preferably has a WUI application object wizard 42 (“AO wizard”), as shown in FIG. 5. Application object wizard 42 includes an accessible application object catalog database 44, a default table 46, and a user preference table 48, each of which is stored there within (see FIG. 2). The application object wizard 42 modifies applications programs and files according to a user-defined preference.

At least one of the terminal service 40 uses x.500 Directory interface with at least one server program to provide authentication to other servers using Lightweight Directory Protocol or similar Protocol directories, thus making crossplatform information retrieval simple.

The terminal service 40 is capable of providing at least one Windows 32 program, such as Client Relations Manager, Microsoft Office, or the like.

As shown in FIG. 2, the terminal service 40 is in communication with application programs 58, such as W32 applications 82, wherein application 82 is in further communication with a filing system 84; a client relations management (CRM) application 86 in further communication with a CRM database 88; and, optimally, with at least one web browser application 90 in further communication with the Internet 60.

The terminal service 40 is in communication with the web-browser application 90. The browser 90 can access the Internet and is in communication with an Internet server such as the web conferencing server 54. Where present, the web-conferencing server 54 is in communication with the world wide web and can be accessed directly via the WUI 38 or can be accessed and modified through the AO wizard 42 of terminal service 40. Additionally, the web-conferencing server 54 is in further communication with a web-conferencing client 102. The E-mail server 50 is in further communication with an web E-mail client 104.

The central storage means 52 provides scalability of the network and may include but is not limited to, a file backup storage, a network attached storage, and a storage area network. Any service on any layer or network 30, except for the client layer, can access the centralized storage.

Additionally, the improved computer network 10 further comprises means 20 for communicating between the server network 30 and the client device 12. The means for communicating 20 between the client device 12 and the server network 30 can be in the form of standard Ethernet cables, employing, for example, Wideband 800Mbs technology, between wired networks such as a LAN or WAN. Additionally, a Virtual Private Network having the client device 12 in communication with the server network 30 may be used to access the network. Additionally, where the client device 12 is a Personal Digital Assistant 100, a cell-phone 1 10, or a VPN of PDA's and cell-phones, the client device 12 may connect to the server network 30 preferably using Wireless Application Protocol (“WAP”).

Additionally, the improved computer network 10 provides means for load-balancing (not shown) to improve server network services and to prevent the network from crashing or cutting off communications between the client device 12 and the server network 30. The means for load-balancing the network 30 may further comprise individual clustering services, such as Novell NetWare® Cluster Services to balance the load on the improved computer network, thus enabling server hardware to swap services and applications, and thus maintaining continuous access of the client device 12 to the server network 30.

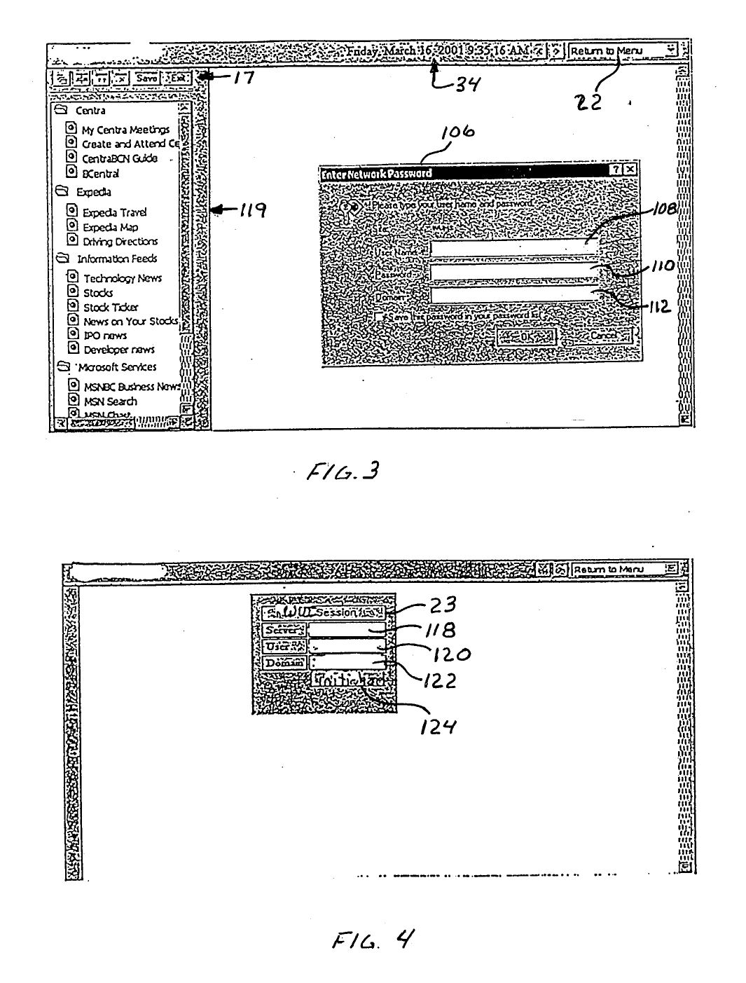

Additionally, the improved computer network 10 preferably provides means for securing access to the server network 30. The means for securing access to the server network 30 employs a security directory Novell E-Directory or Microsoft Active Directory which is part of the x.500 Directory interface to first authenticate a user by using an authentication means and then verify authorization of the user to access the server network 30 by using an authorization means. As shown in FIG. 3, the means for securing access to the network server may be accessed through the client device 12 by turning on the client device 12, viewing a security menu 106 displayed in the viewing portion 21 of the configurable browser 14 and entering a user name, a password, and a domain name in the respective fields 108,110, 112.

As shown in FIG. 4, a WUI session may be initialized through a WUI initialization or launch menu 23, by entering a server ID, a username, and a domain name in a respective server field 118, a user field 120, and a domain field 122, of the launch menu. Additionally, the WUI URL site must be entered in the address portion 16 of the configurable browser 14 as shown in FIG. 5. Once the information is entered the configurable browser 14 communicates with the server network 30 via the WUI by first authenticating the user and granting the user authorization to access the server network.

Additionally, the improved server network 10 may have means for preventing an unauthorized user from accessing the server network. Such means for preventing may be in the form of a firewall that filters communications from devices outside the server network. Preferably, a firewall such as the Novell BorderManagerTM may be employed to prevent unauthorized users from accessing the server network 30.

In a preferred embodiment shown in FIG. 5-13, screens displaying steps for a method of using the improved computer network 10 to create a customized application object using the application object builder 42 embodied in the WUI 38 are shown. The application object builder 42 can create a virtual sticky note by automating the creation of simple application objects used for creating the virtual sticky note or can customize an application by employing the method described herein below.

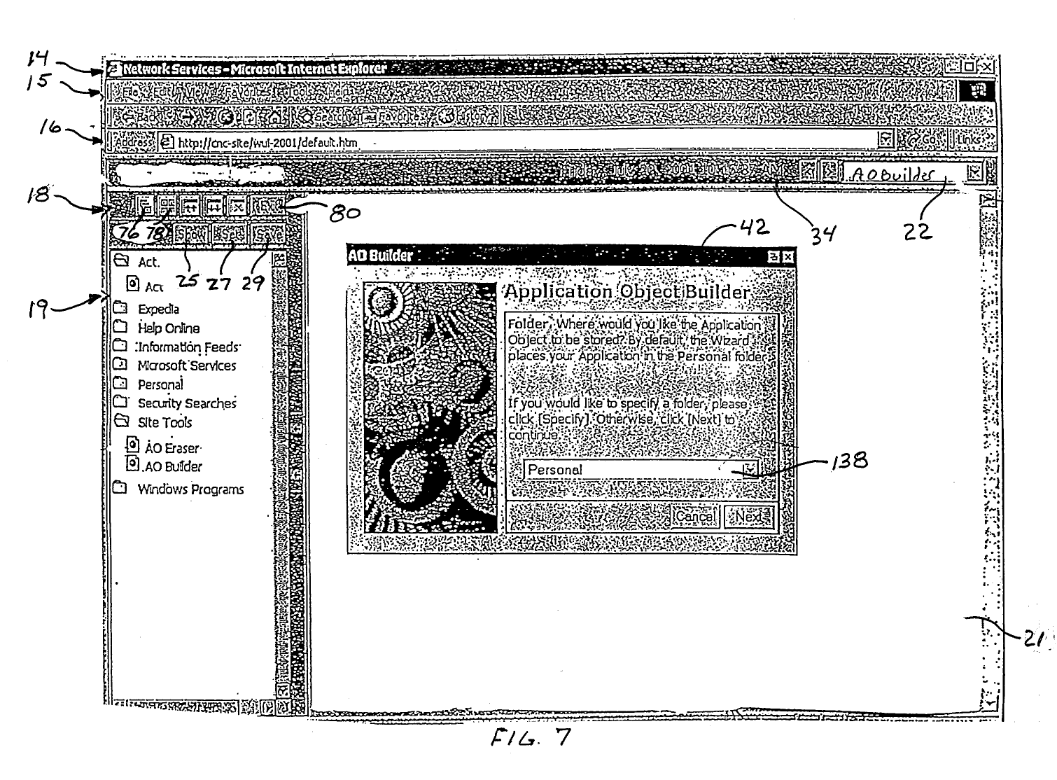

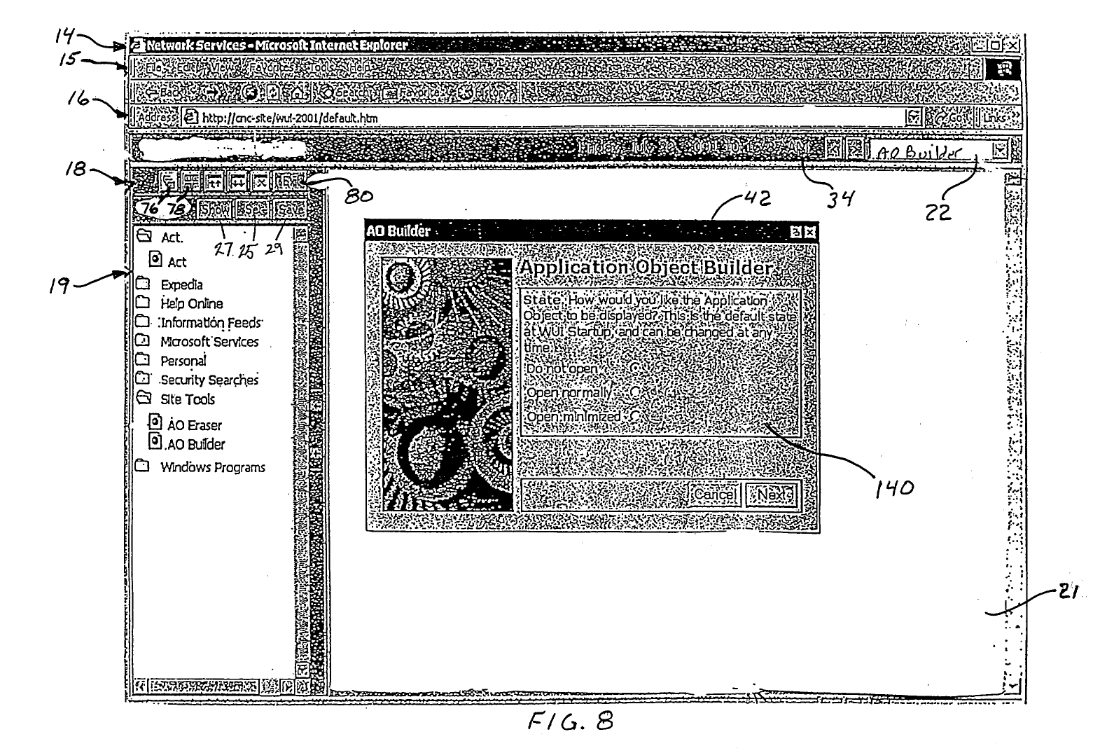

As shown in FIG. 5, the first step to customize or create an application object after obtaining secure access to the network server 30 using the WUI 38 is to select a folder from the catalog of WUI files 19 and to further select an AO Builder button 138. After selecting the AO Builder button 138, the application object builder 42 is displayed on the application viewing portion 21 of the configurable browser 14. Next, as shown in FIGS. 6-7, an application object and application object folder is named by entering text in the fields 136 and 138 respectively. A user's AO display preference is selected from a AO builder user preference menu 140 as shown in FIG. 8. This preference is stored in the application builder user preference table 48 on the terminal service 40 (see FIG. 2).

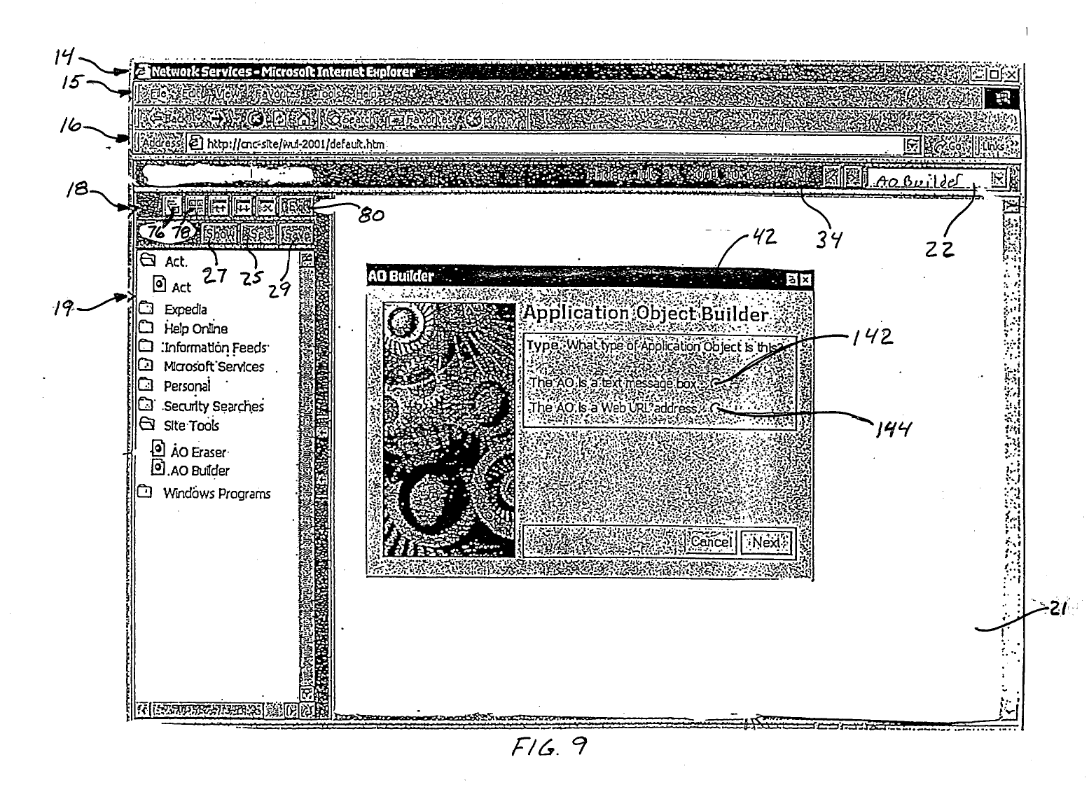

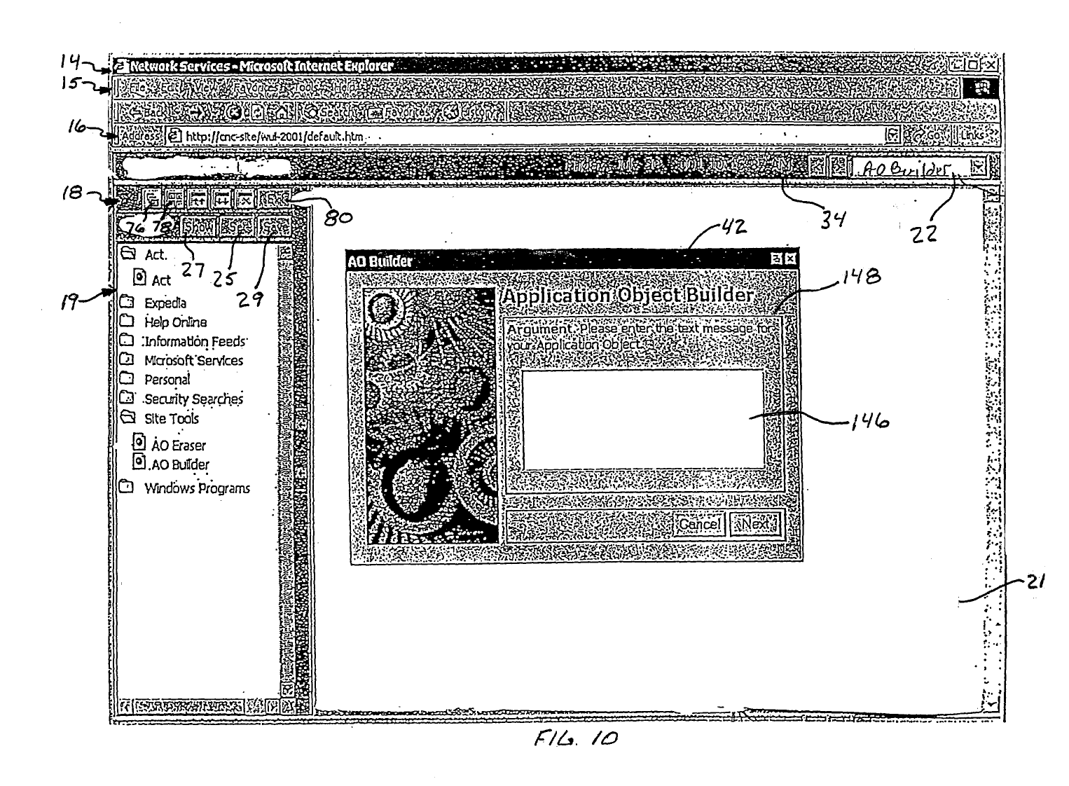

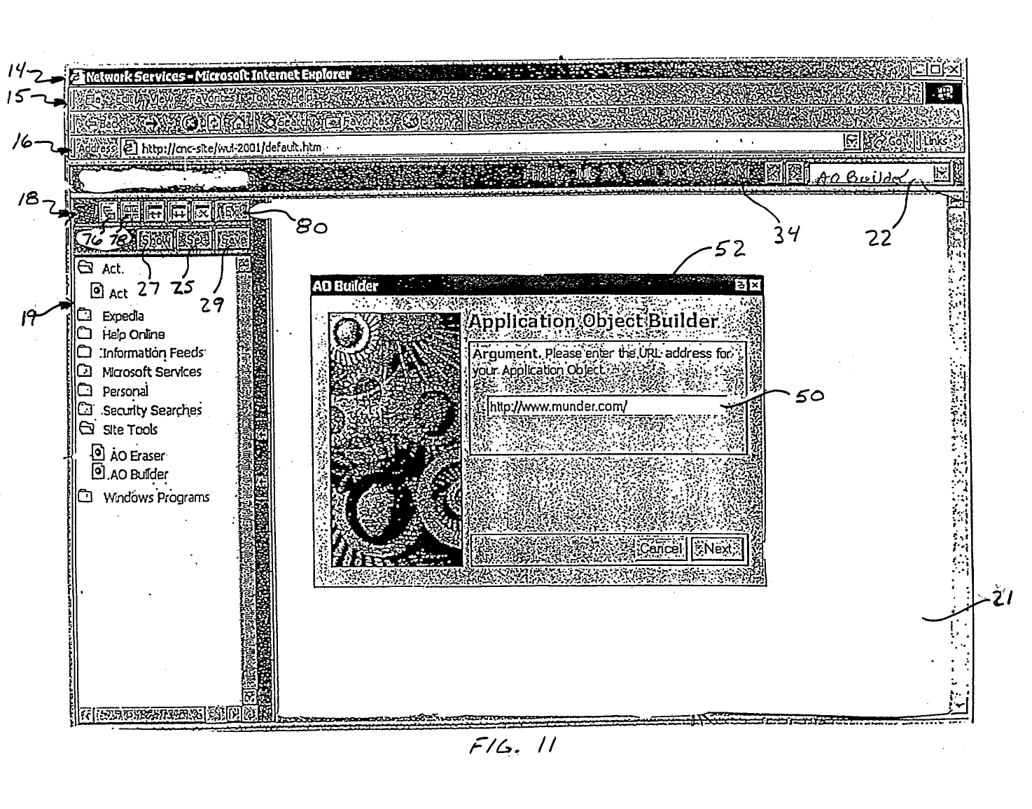

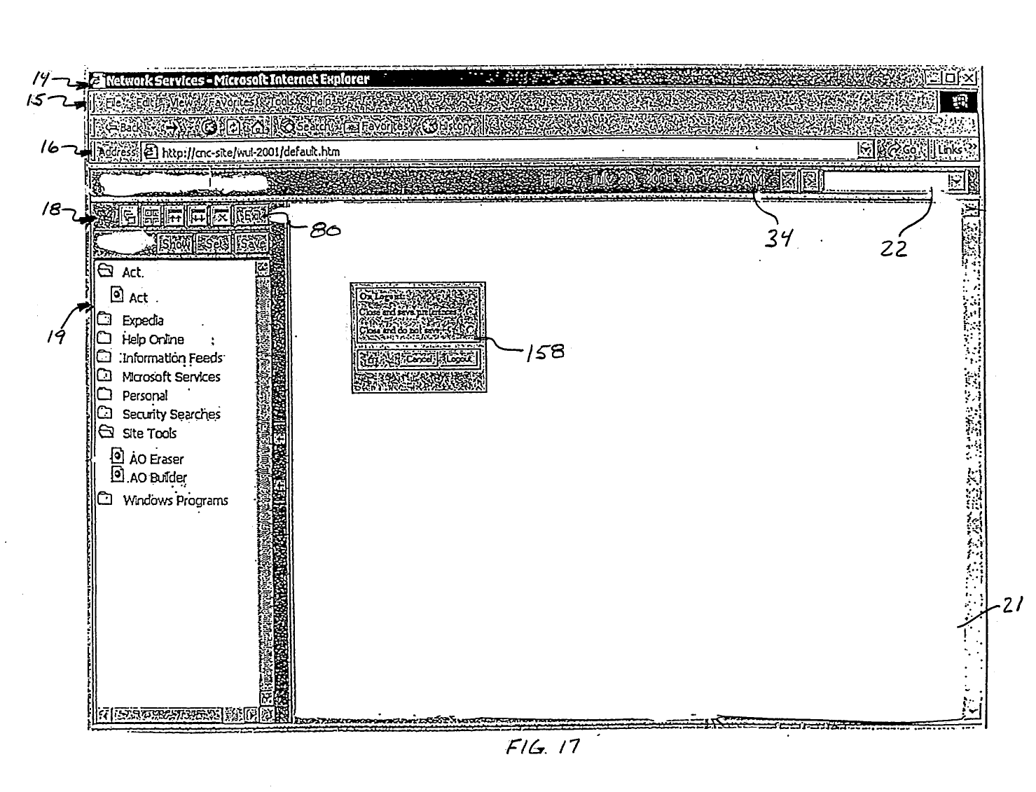

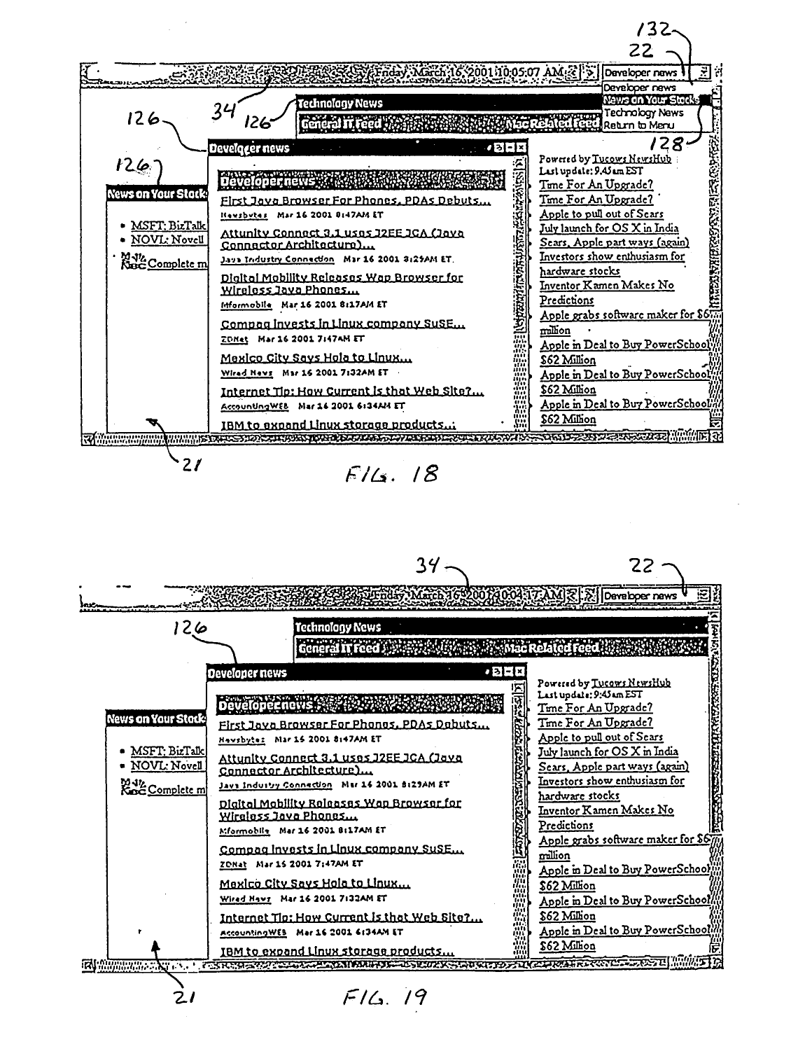

After defining the user's application display preference, the user can select the type of AO to be created by choosing to create either a text message AO by selecting the “text message box” 142 option or a Web page AO by selecting the AO “Web URL address” box 144 option as shown in FIG. 9. Referring to FIG. 10, to create the text message after selecting the text message box 142, the user may enter a text message in field 146 of the Application Object Builder Argument screen 148. After selecting the type of AO to be created, a URL address 50 is entered for a newly created application object 126 (see FIG. 18 and 19), as shown in FIG. 11, to be stored on the server network 30.

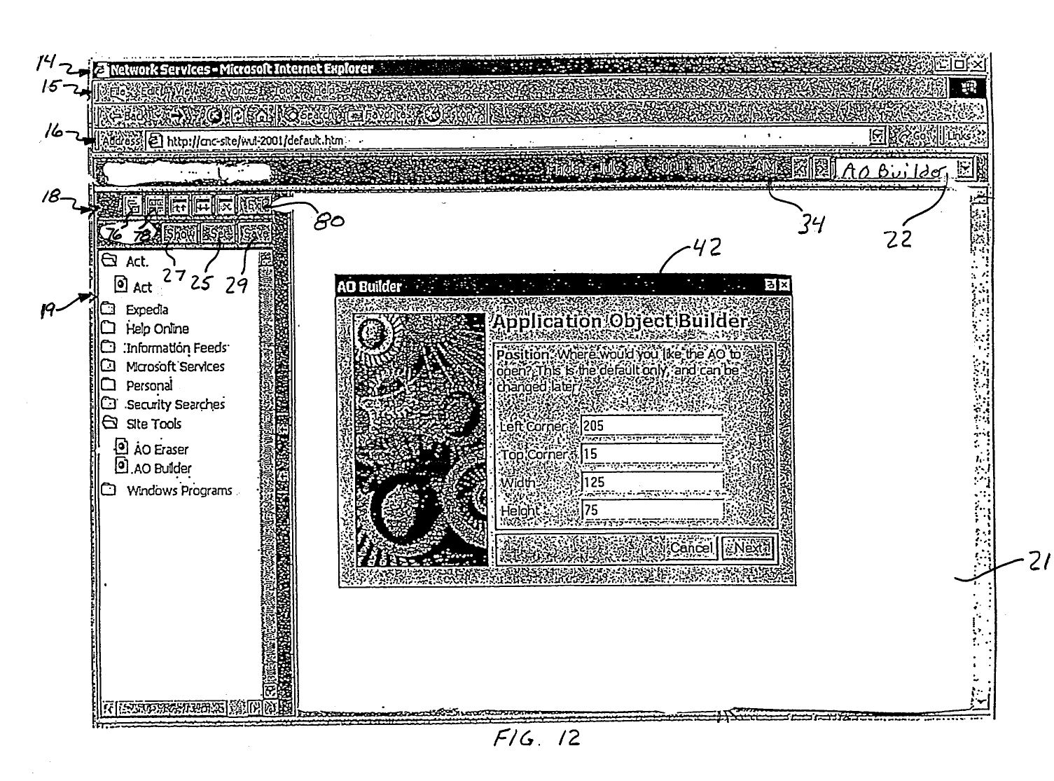

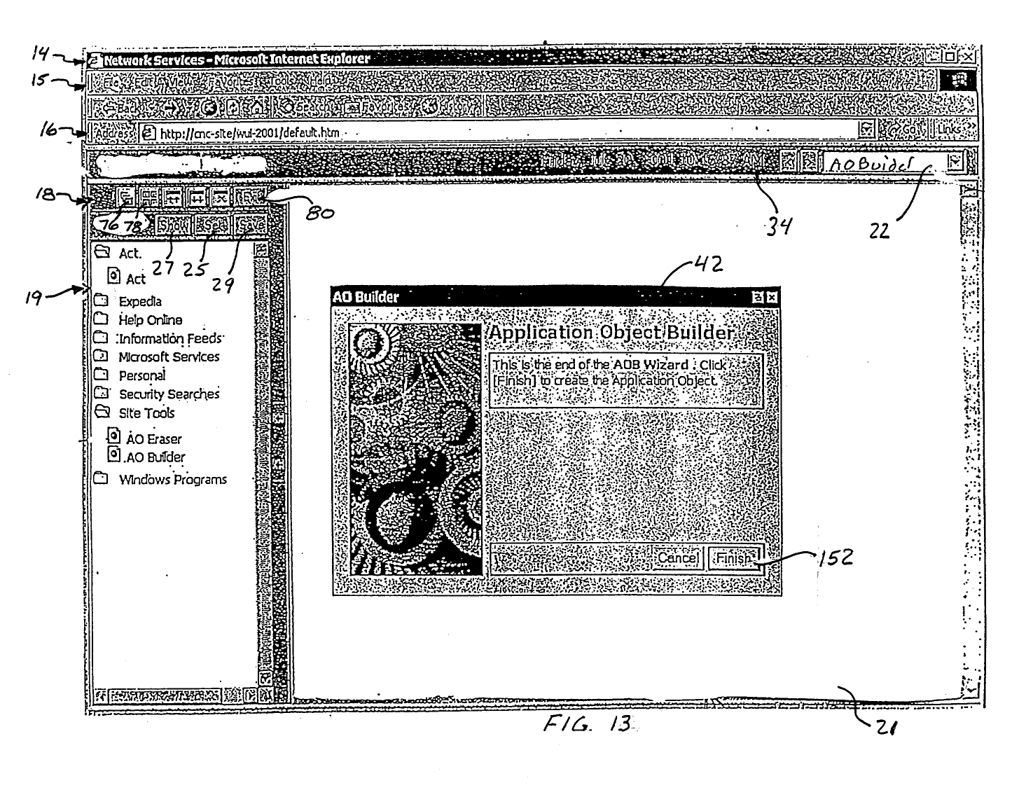

After storing the newly created application object 126, as shown in FIG. 12, a pixel size and location is selected for the AO to be displayed on the application viewing portion 21 of the configurable browser 14. As shown in FIG. 13, to close out of the Application Builder 42, a finish button 152 on the application object builder 42 is selected. After selecting the finish button 152 of Application Object Builder, the AO will be displayed at the screen position specified during the AO creation process.

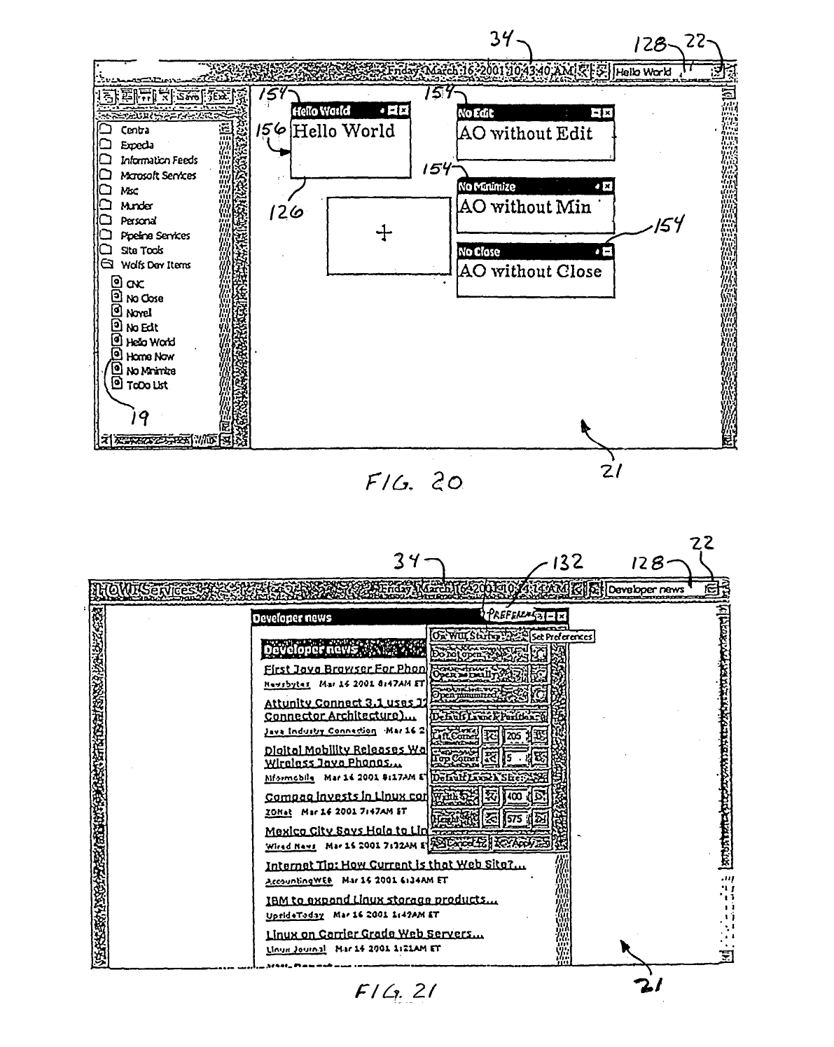

There are two methods for selecting an existing AO on the WUI desktop 21. These methods include: 1) selecting the AO from a AO title name 128 displayed on the jump bar 22 as shown in FIGS. 18-19, or 2) selecting the AO title bar 154 of a displayed AO object icon 156 displayed on the WUI desktop 21 as shown in FIG. 20. After selecting the existing AO 126 on the WUI desktop, the AO 126 may also be moved to a user-defined position.

To further define preferences for an existing application object after selecting a “Show” button 27 on command bar 18, the “Set” button 25 is selected from the command bar 18. As shown in FIG. 21, a drop down Preferences menu 132 is then displayed allowing selection of a user's display preferences. The user's display preferences preferably includes selecting viewing characteristics of the AO, including a AO default display screen position and a viewing size of the AO, and also selecting a default WUI initialize or launch behavior setting of the AO display wherein the AO is either automatically displayed on the WUI desktop 21 in a maximized or a minimized state, or is not automatically displayed after initializing a WUI session. After selecting the user's preferences a user may save these preferences so that during a next WUI session the AO will be displayed according to the user's pre-defined preferences.

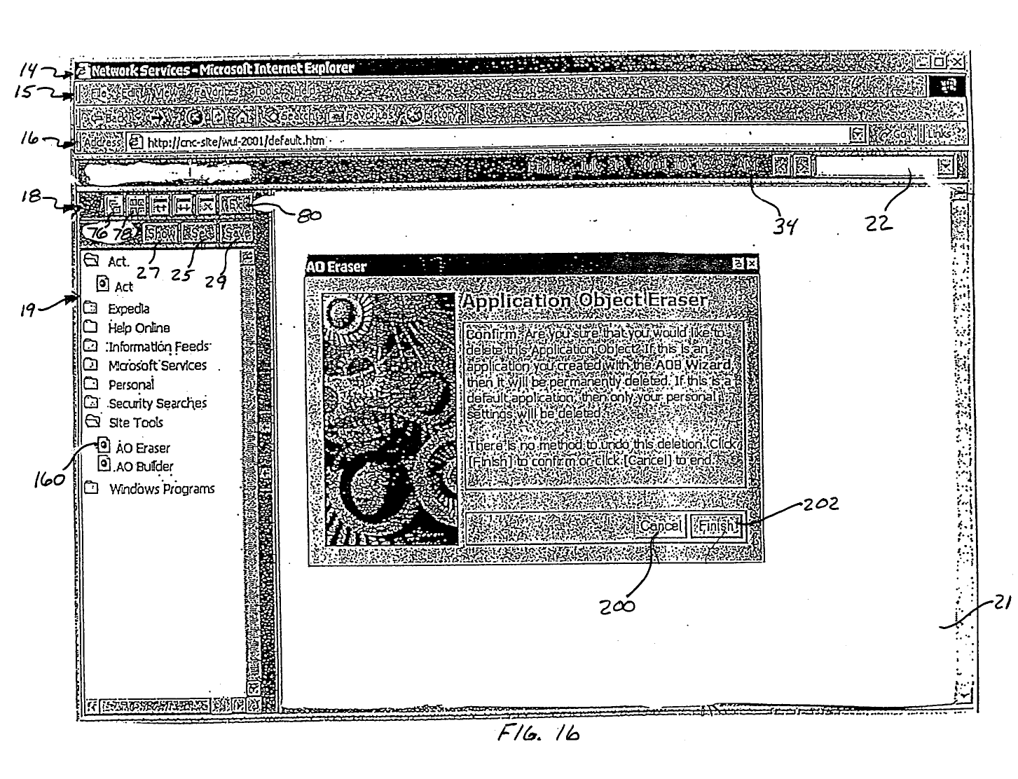

To save an existing AO 126 on the server network 30, as shown in FIG. 17, a user may select a “Save” button 29 from the command bar 18. Additionally, the user may save the AO 126 by selecting the “Exit” button 80 from the command bar 18 and saving the existing AO 126 upon exiting or logging-off the WUI. When exiting the WUI, a user-preference save choice menu 158 is displayed wherein a user may choose to either save or not save the user-defined preferences and then may exit the current WUI session.

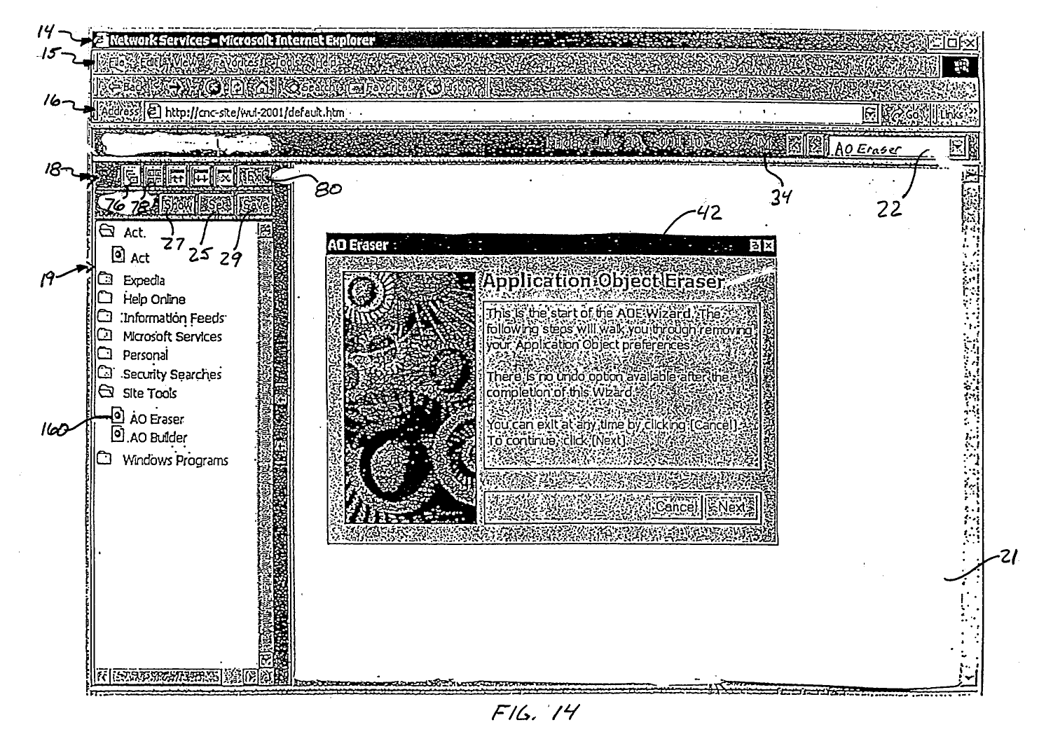

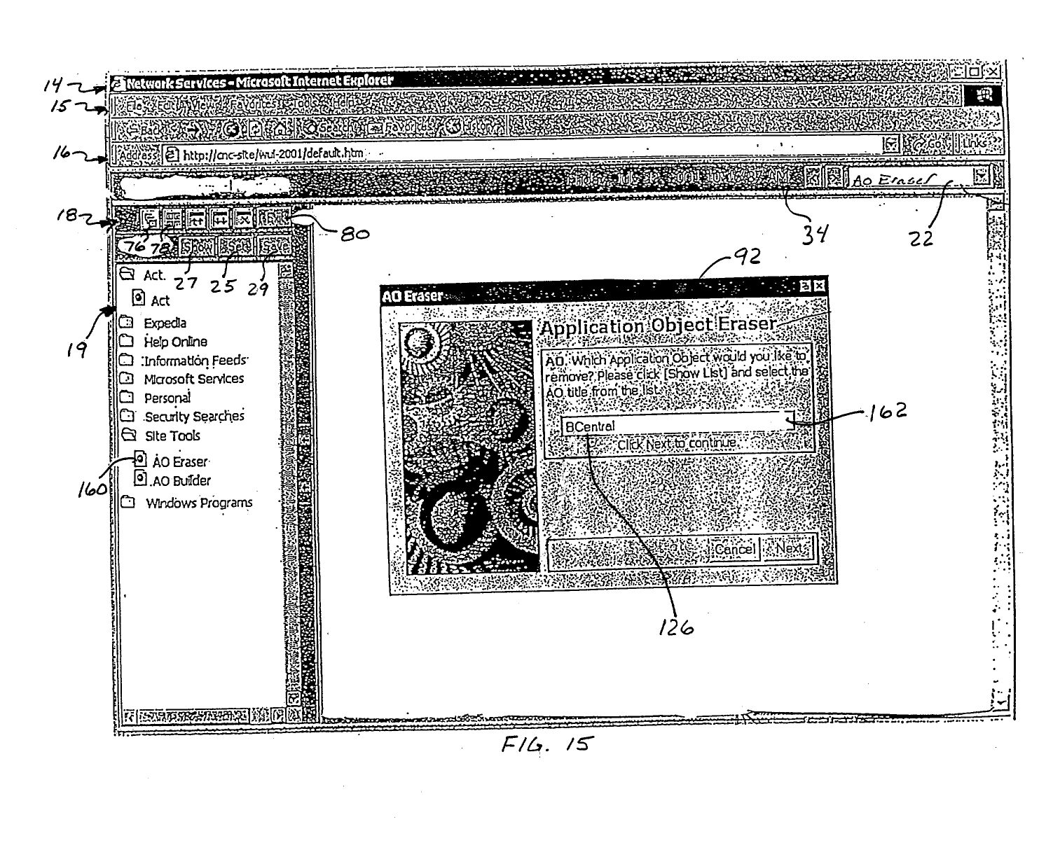

Additionally, as shown in FIG. 14, if the user chooses to delete the preferences, then the AO Eraser folder 160 is selected from the Menu catalog 19 or from the jump bar 22. As shown in FIG. 15, the user may then select the existing AO 126 from a drop down menu 162 that the user wishes to delete. Upon selecting the AO 126 to be deleted, the user may either choose to cancel by selecting a “Cancel” button 200, or confirm the deletion by selecting the “Finish” button 202 as shown in FIG. 16.

While various aspects of the web user interface using a single portal have been disclosed, it will be appreciated that many other variations may be incorporated without departing from the scope of the present invention. It is intended by the following claims to cover any departures from the disclosed embodiments which fall within the true spirit of the invention. The description of the invention is merely exemplary in nature and, thus, variations that do not depart from the gist of the invention are intended to be within the scope of the invention. Such variations are not to be regarded as a departure from the spirit and scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer network comprising:
at least one client device;
a server network; and
a web user interface having a single portal operably connecting the at least one client device to the server network.

2. The computer network of claim 1, wherein the server network is comprised of a plurality of servers.

3. The computer network of claim 2, wherein at least one of the servers is comprised of a terminal service.

4. The computer network of claim 3, wherein the terminal service is comprised of an application object wizard.

5. The computer network of claim 4, wherein the application object wizard is comprised of:
an application object catalog database;
a user preference table; and
a default table.

6. The computer network of claim 3, further comprising:
an application program that operably communicates with the terminal service;
a file system in operable communication with the application program; and
a central storage means operably connected to the file system.

7. The computer network of claim 3, further comprising:
a client relations management application that operably communicates with the terminal service;
a client relations management data base that operably communicates with the client relations management application; and
a central storage means operably connected to the client relations management data base.

8. The computer network of claim 2, wherein at least one of the servers is comprised of a web conferencing server.

9. The computer network of claim 8, further comprising a web conference client that operably communicates with the web conferencing server and the web user interface.

10. The computer network of claim 8, further comprising a central storage means operably connected to the web conferencing server.

11. The computer network of claim 2, wherein at least one of the servers is comprised of an E-mail server.

12. The computer network of claim 11, further comprising a web E-mail client that operably communicates with the E-mail server and the web user interface.

13. The computer network of claim 12, further comprising a central storage means operably connected to the E-mail server.

14. The computer network of claim 2, wherein each server operably communicates with every other server.

15. The computer network of claim 2, wherein all of the servers operably communicates with the web user interface.

16. The computer network of claim 1, wherein the web user interface further comprises means for authenticating a user and securing access to the server network.

17. The computer network of claim 1, further comprising means for load-balancing the server network to improve performance of the server network and to prevent interruption of communication between the at least one client device and the server network.

18. The computer network of claim 1, further comprising means for preventing an unauthorized user from accessing the server network.

19. The computer network of claim 1, wherein the at least one client device is comprised of a computer.

20. The computer network of claim 1, wherein the at least one client device is comprised of a display device.

21. The computer network of claim 20, wherein the display device has a configurable browser.

22. The computer network of claim 1, comprising a plurality of client devices, the devices being networked together to form at least a portion of a local area network.

23. The computer network of claim 1, comprising a plurality of client devices, the devices being operably networked together to form at least a portion of a wide area network.

24. The computer network of claim 1, comprising a plurality of client devices, the client devices being networked together to form at least a portion of a virtual private network.

25. The computer network of claim 1, wherein the at least one client device is a cell phone.

26. The computer network of claim 1, wherein the at least one client device is a personal digital assistant.

27. A method of using a computer network having a single portal web user interface and an application object builder to create a customized application object, comprising the steps of:
using the web user interface to access the application object builder through the portal;
displaying the application object builder on a client device;
using the application builder to create the customized application object; and
storing the customized application within a memory location of a memory device.

28. The method of claim 27, wherein the step of using the application builder to create the customized application object is comprised of the steps of:
providing a name for the customized application object in response to a query generated by application object builder;
specifying a memory location within the memory device for storing the application object in response to a query generated by application object builder;
selecting a display preference for the application object from a plurality of choices that are provided by the application object builder;
selecting the type of application object that is being created from a series of choices generated by the application object builder; and
specifying the size and location of the application object when the application object is opened and displayed on the client device.

29. The method of claim 28, further comprising the step of specifying a text message for the application object.

30. The method of claim 28, further comprising the step of specifying a Uniform Resource Locater for the application object.

31. A method of using a computer network having a single portal web user interface and an application object builder to modify a customized application object, comprising the steps of:
using the web user interface to access the application object builder through the portal;
displaying an application object and an application program retrieved from a terminal service on the client device;
using the application object builder to modify the application object retrieved from the terminal service on the client device according to an end-user's preference; and
storing the modified application object in an application object database in communication with the terminal service.
